(19) United States
(12) Patent Application Publication
(10) Pub. No.: US 2003/0147141 A1
(43) Pub. Date: Aug. 7, 2003

(54) Television projection screen

(76) Inventor: Shih-Chieh Tang, Tainan City (TW)

Correspondence Address: Bacon & Thomas, 625 Slaters Lane - 4th Floor, Alexandria, VA, 22314, US

(21) Appl. No.: 10/060,389

(22) Filed: Feb. 1, 2002

(51) Int. Cl. G02B 5/02; G02B 13/20; G02B 27/00

(52) U.S. Cl. 359/609; 359/601; 359/599

(57) ABSTRACT

A television projection screen comprises a Fresnel lens sheet and a diffusing lens sheet. The Fresnel lens sheet is disposed face-to-face to a light incident surface of the diffusing lens sheet. Plural concave lenses and plural light-absorbing layers are arranged on a light emitting surface of the diffusing lens sheet. The concave lenses and the light-absorbing layers are alternately disposed in a parallel manner. The projection light rays incident to the light incident surface of the diffusing lens sheet are guided to the concave lenses on the light emitting surface of the diffusing lens sheet and then refracted from the concave lenses, thereby diffusing the projection light rays. By means of providing plural concave lenses on the light emitting surface of the diffusing lens sheet, the projection light rays are diffused while simplifying the structure and reducing the thickness.

### BACKGROUND OF THE INVENTION

1. Field of the Invention

The present invention relates to a television projection screen comprising a diffusion lens sheet having plural concave lenses on a light emitting surface thereof for guiding the incident light ray to create refraction, thereby forming diffusion of the emitted light. In addition, each concave lens includes a fogged layer to enhance diffusion of the transmitted light.

2. Description of the Related Art

FIG. 1 of the drawings illustrates a conventional television projector in which the light from a projection light source 1 is projected to a specific location on a projection screen 10 after reflection, thereby generating an image on the specific location of the projection screen 10. The projection screen 10 is comprised of plural optical lenses. FIG. 2 is a sectional view of the projection screen 10. The projection screen 10 includes a Fresnel lens sheet 11, a lenticular lens sheet 12, and a front plate 13. The Fresnel lens sheet 11 refracts the incident light rays from the projection light source 1 into parallel light rays. The lenticular lens sheet 12 refracts the parallel light rays from the Fresnel lens sheet 11 to form diffusion and thus generate a projection image on the front plate 13.

Plural convex lenses 12a are arranged parallel to each other on a rear face of the lenticular lens sheet 12. Arranged on a front face of the lenticular lens sheet 12 are plural convex lenses 12b and plural light-absorbing layers 12c. In this lenticular lens sheet 12, the convex lenses 12a respectively correspond to the convex lenses 12b, and each convex lens 12a has a width greater than that of each convex lens 12b. Each convex lens 12a refracts the projection light ray to the associated convex lens 12b. In this case, the light-absorbing layers 12c on both sides of each convex lens 12b absorb refracted light rays beyond a predetermined angle. Thus, the light-absorbing layers 12c limit the refraction range of the convex lenses 12b.

U.S. Pat. No. 5,880,887 to Goto issued on Mar. 9, 1999, entitled “LENTICULAR LENS SHEET, DISPLAY FRONT PLATE AND TRANSMISSION TYPE PROJECTION SCREEN,” discloses a projection screen comprised of a Fresnel lens sheet, a lenticular lens sheet, and a display front plate. In addition, U.S. Pat. No. 6,049,423 issued to Okuda on Apr. 11, 2000, entitled “REAR PROJECTION SCREEN INCLUDING A LENTICULAR LENS WITH CLEAR AND DIFFUSING LAYERS ON LIGHT RECEIVING AND EMITTING SIDES, RESPECTIVELY,” discloses a projection screen comprised of a Fresnel lens sheet and a lenticular lens sheet. The structures of the projection screens disclosed in these two patents are substantially similar to that shown in FIGS. 1 and 2, which are incorporated herein for reference.

As illustrated in FIG. 2, the lenticular lens sheet 12 comprises plural convex lenses 12a, plural convex lenses 12b, and plural light-absorbing layers 12c. The convex lenses 12a and 12b on front and rear faces of the lenticular lens sheet 12 are provided to enhance the diffusion of the projection light rays, but the structure of the lenticular lens sheet 12 becomes complex and the thickness of the lenticular lens sheet 12 is increased. It would be able to reduce the production time and to save the cost if the structure of the lenticular lens sheet 12 is simplified and the thickness of the lenticular lens sheet 12 reduced.

### SUMMARY OF THE INVENTION

It is the primary object of the present invention to provide a television projection screen comprising a diffusion lens sheet having plural concave lenses arranged on a light emitting surface thereof in a parallel manner for guiding the incident light ray to create refraction, thereby forming diffusion of the emitted light.

It is the secondary object of the present invention to provide a television projection screen comprising a diffusion lens sheet having plural concave lenses on a light emitting surface thereof for guiding the incident light ray to create refraction, thereby forming diffusion of the emitted light. The structure is thus simplified and the thickness is reduced.

It is another object of the present invention to provide a television projection screen comprising a diffusion lens sheet having plural concave lenses arranged on a light emitting surface thereof in a parallel manner. Each concave lens includes a fogged layer to enhance diffusion of the transmitted light.

A television projection screen in accordance with the present invention comprises a Fresnel lens sheet and a diffusing lens sheet. The Fresnel lens sheet is disposed face-to-face to a light incident surface of the diffusing lens sheet. Plural concave lenses and plural light-absorbing layers are arranged on a light emitting surface of the diffusing lens sheet. The concave lenses and the light-absorbing layers are alternately disposed in a parallel manner. The projection light rays incident to the light incident surface of the diffusing lens sheet are guided to the concave lenses on the light emitting surface of the diffusing lens sheet and then refracted from the concave lenses, thereby diffusing the projection light rays.

In accordance with the present invention, by means of providing plural concave lenses on the light emitting surface of the diffusing lens sheet, the projection light rays are diffused while simplifying the structure and reducing the thickness. In addition, each concave lens includes a fogged layer to enhance diffusion of the transmitted light rays.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a schematic perspective view of a conventional television projector.

FIG. 2 is a sectional view of a projection screen of the conventional television projector.

FIG. 3 is a partial sectional view of a television projection screen of a preferred embodiment in accordance with the present invention.

FIG. 4 is a schematic view illustrating refraction of a diffusing lens sheet of the television projection screen in accordance with the present invention.

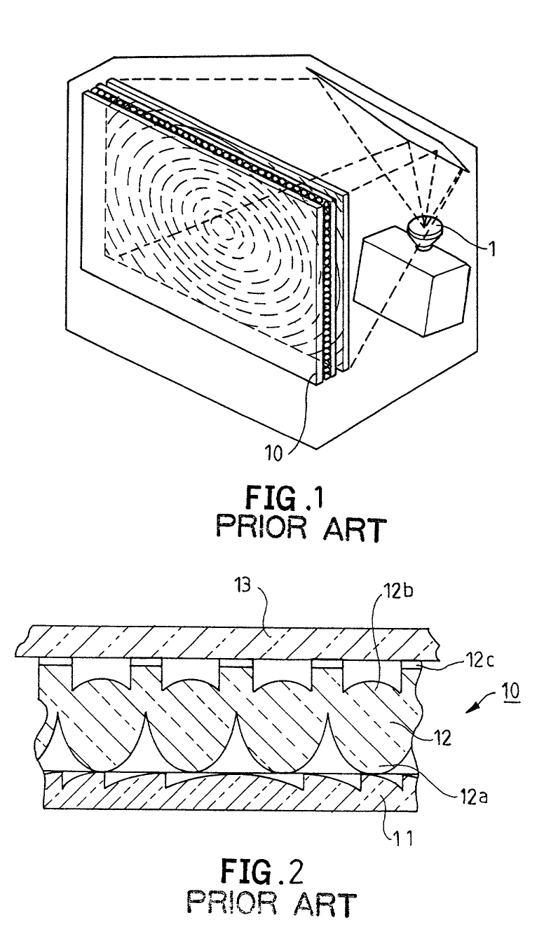

### DETAILED DESCRIPTION OF THE PREFERRED EMBODIMENT

A preferred embodiment in accordance with the present invention will now be described with reference to the accompanying drawings.

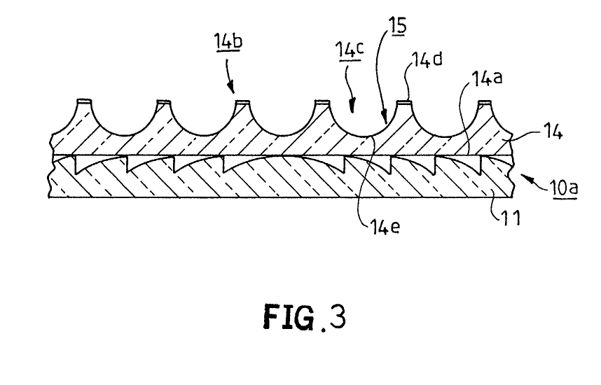

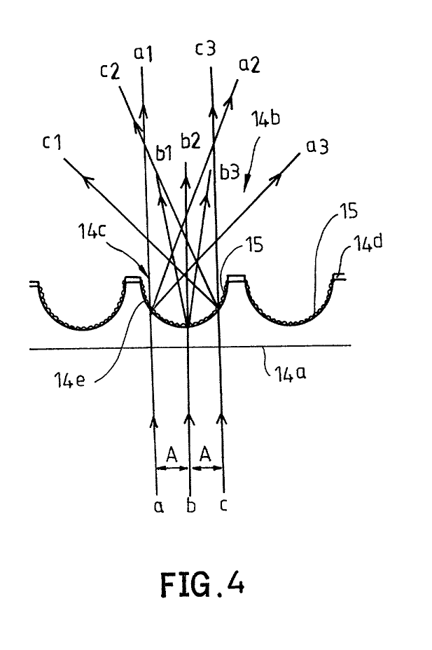

Referring to FIG. 3, a television projection screen 10a in accordance with the present invention generally includes a Fresnel lens sheet 11 and diffusing lens sheet 14. The Fresnel lens sheet 11 is disposed face-to-face to a light incident surface 14a of the diffusing lens sheet 14. Thus, the projection light ray passes through the Fresnel lens sheet 11 and the diffusing lens sheet 14 in sequence. Plural concave lenses 14b and plural light-absorbing layers 14d are arranged on a light emitting surface 14b of the diffusing lens sheet 14. The concave lenses 14c and the light-absorbing layers 14d are alternately disposed in a parallel manner. Each concave lens 14c includes a concave face 14e of a specific curvature, such as a semi-circle, thereby having a specific refractivity. The concave face 14e of each concave lens 14c further includes a fogged layer 15 to enhance the diffusion effect, best shown in FIG. 4, which will be described in detail later.

The light-absorbing layers 14d on both sides of each concave lens 14c absorb refracted light rays beyond a pre-determined angle. Thus, the light-absorbing layers 14d limit the refraction range of the concave lenses 14c. The diffusing lens sheet 14 includes a diffusing agent the amount and concentration of which determine the refractivity of the diffusing lens sheet 14. Projection light ray is incident to and thus guided by the light incident surface 14a of the diffusing lens sheet 14, and then refracted through the light emitting surface 14b of the diffusing lens sheet 14, thereby diffusing the projection light ray. The light incident surface 14a of the diffusing lens sheet 14 is planar. Only plural concave lenses 14c are arranged on the light emitting surface 14b. The structure of the projection screen is simplified and the thickness thereof is reduced without adversely affecting the diffusion effect for the projection light ray.

Referring to FIGS. 1 and 3, in a television projector, the projection light from the projection light source 1 is projected to a specific location of the projection screen 10 after reflection, thereby forming an image on the specific location of the projection screen 10. The projection screen 10a in accordance with the present invention may be used with such a television projector.

FIG. 4 illustrates refraction of the diffusing lens sheet 14 of the projection screen in accordance with the present invention. In FIG. 4, a first light source, a second light source, and a third light source are incident to the diffusing lens sheet 14 in a perpendicular direction and at specific angles, respectively. The refraction of the light rays is analyzed below. In structure, the fogged layer 15 on the concave face 14e of each concave lens 14 forms a rugged face that is comprised of particles of different sizes. A diffusion effect is generated when the transmitted light ray passes through the particles. Thus, the fogged layer 15 enhances the diffusing function of the diffusing lens sheet 14.

Referring to FIG. 4, two light-absorbing layers 14d are provided on both sides of each concave lens 14c. The concave face 14e of each concave lens 14 has a uniform, symmetric curvature. The three parallel light sources a, b, and c are used to show refraction of the light rays passing through the concave lenses 14c. The light sources a, b, and c at different locations (with a space A between each other) are incident to the light incident surface 14a. The light source a includes light rays a1, a2, and a3 that are directly incident to the light incident surface 14a of the diffusing lens sheet 14 without refraction and directly reach the concave face 14e of the convex lens 14c. When the light source a transmits through the fogged layer 15, the light rays a2 and a3 are refracted toward a side of the concave face 14e and generate a diffusion effect. The light ray a1 is not refracted. The diffusing directions of the light rays a1, a2, and a3 leaving the light emitting surface 14b of the diffusing lens sheet 14 show a uniform diffusing effect.

Still referring to FIG. 4, the light source c includes light rays c1, c2, and c3 that are directly incident to the light incident surface 14a of the diffusing lens sheet 14 without refraction and directly reach the concave face 14e of the convex lens 14c. When the light source c transmits through the fogged layer 15, the light rays c1 and c2 are refracted toward the other side of the concave face 14e and generate a diffusion effect. The light ray c3 is not refracted. The diffusing directions of the light rays c1, c2, and c3 leaving the light emitting surface 14b of the diffusing lens sheet 14 show a uniform diffusing effect.

Still referring to FIG. 4, the light source b includes light rays b1, b2, and b3 that are directly incident to the light incident surface 14a of the diffusing lens sheet 14 without refraction and directly reach the concave face 14e of the convex lens 14c. When the light source b transmits through the fogged layer 15, the light rays b1 and b3 are respectively refracted toward two sides of the concave face 14e and generate a diffusion effect. The light ray b2 is not refracted.

Conclusively, for the incident light sources a, b, and c, the diffusing directions of the light rays a2, a3, b1, b3, c1, and c2 leaving the light emitting surface 14b of the diffusing lens sheet 14 show a uniform diffusing effect, while the light rays a1, b2, and c3 travel along the incident directions, respectively. Thus, the concave lenses 14c may enhance diffusion effect for the projection light rays from any projecting orientations.

Still referring to FIGS. 3 and 4, the concave lenses 14 arranged parallel to each other constitute the light emitting surface 14b of the diffusing lens sheet 14. The light emitting surface 14b of the diffusing lens sheet 14 enhances the diffusion due to the diffusion-enhancing function provided by the concave lenses 14c.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A television projection screen comprising:
a Fresnel lens sheet for refracting incident projection light rays into parallel light rays; and
a diffusing lens sheet comprising a light incident surface and a light emitting surface, the light incident surface being planar, the light emitting surface including plural concave lenses and plural light-absorbing layers, said plural concave lenses and said plural light-absorbing layers being alternately disposed in a parallel manner;
the projection light rays incident to the light incident surface of the diffusing lens sheet being guided to the concave lenses on the light emitting surface of the diffusing lens sheet and then refracted from the concave lenses, thereby diffusing the projection light rays.

2. The television projection screen as claimed in claim 1, wherein each said concave lens on the light emitting surface of the diffusing lens sheet further includes a fogged layer to enhancing diffusion of transmitted light rays.

3. The television projection screen as claimed in claim 2, wherein the fogged layer forms a rugged surface that is comprised of particles of different sizes.

4. The television projection screen as claimed in claim 1, wherein the diffusing lens sheet includes a diffusing agent an amount and concentration of which determines refractivity of the diffusing lens sheet.

5. The television projection screen as claimed in claim 1, wherein each said concave lens includes a semi-circular concave face.
